(19) United States
(12) Patent Application Publication
(10) Pub. No.: US 2003/0055762 A1
(43) Pub. Date: Mar. 20, 2003

(54) Incremental active user profile construction for content customization interspersed with content display

(76) Inventor: Laurence E. Holt, London (GB)

Correspondence Address: LAW OFFICES OF MICHAEL DRYJA, 704 228TH AVENUE NE, PMB 694, SAMMAMISH, WA, 98074, US

(21) Appl. No.: 09/682,545

(22) Filed: Sep. 18, 2001

(51) Int. Cl. G06F 17/60; G06F 7/00; G06F 17/30

(52) U.S. Cl. 705/36; 705/10; 705/7; 707/10

(57) ABSTRACT

The incremental construction of active user profiles for subsequent content customization based thereon, interspersed with content display, is disclosed. Content is displayed based at least on an active profile for a user, where the active profile may initially be empty. The content includes an inquiry area that has one or more questions. The answers to these questions allow for better construction of the profile. The user may answer the questions, or may ignore them and select other content to display. In the latter case, new content is shown to the user, with preferably the same questions displayed to the user in the inquiry area. In the former case, the active profile for the user is updated based on the answers, and the existing content is preferably refreshed to reflect the updated active profile. The inquiry area of the refreshed content then displays new questions.

### BACKGROUND OF THE INVENTION

This invention relates generally to the customization of content, and more particularly to the construction of a user profile on which basis such customization is accomplished.

One of the more popular uses of the Internet is browsing its worldwide web (WWW), or “the web.” A user on his or her computer, running a web browsing computer program such as Microsoft Internet Explorer or Netscape Navigator, requests content at a web site by its address, or universal resource locator (URL). A server hosting the web site receives the request, and in response sends the content back to the user's computer, which displays the content to the user. In this manner, the user has access to a wide variety of different types of content, such as news, sports, entertainment, and other types of content.

More recently, web site operators have attempted to customize the content returned to their users, so that the users have a more enjoyable browsing experience. Usually, web site operators attempt such customization by storing a user profile for each user, either at the web server, or at the users' individual computers. In the former instance, the profiles may be stored on a database to which the web server has access. In the latter instance, a user's profile may be stored as a small file on the user's computer, which is typically referred to as a “cookie.” Furthermore, a combination of both of these approaches may be used.

Profiles may be constructed in a passive or an active manner. Passive profile construction may involve tracking a user as he or she browses a web site, as well as using other information about the user that he or she did not specifically input for this purpose. That is, passive profiles are constructed without direct interaction with and input from the user for this purpose. For example, in a given visit to a web site, the user may usually request a web page that shows the latest sports scores for a given sports team. Based on this information, the web site may be customized to automatically show these latest sports scores to the user when he or she next visits the site. As another example, the user on an electronic commerce (“e-commerce”) web site may have purchased astronomy-related books. Based on this information, the web site may be customized to automatically show other astronomy-related books to the user when next visiting the site.

Passive profile construction is limited in its utility, however, because the user is not directly asked for the information contained within the profile, but rather is tracked to attempt to glean this information. For example, the user may be usually requesting a web page that shows the latest sports scores for a given sports team because a family member is using the user's computer temporarily, such that the user him or herself does not wish to have these latest scores shown automatically when visiting the web site. As another example, the user may have purchased astronomy-related books on an e-commerce site as a gift for a colleague, and may not particularly be interested in astronomy him or herself. In other words, the conclusions drawn from such passive profile construction may not be correct as to the preferences of the user.

By comparison, active profile construction directly involves the user in the construction of a profile for him or her, such that subsequent displays of content are customized based on this profile. Typically, a user is asked a series of questions, such as areas of interest, demographic information, and so on. For example, if the user indicates that he or she is interested in international news, but not as interested in sports, the web site may customize the content so that international news, but not sports information, is automatically shown to the user when he or she visits the site. An e-commerce site may ask the user the types of books that are of interest to the user, and inform the user when new books of these types become available. Active profile construction, in other words, does not have to rely on drawing conclusions about a user's content preferences, because the user is directly asked about his or her preferences.

A downside to active profile construction, however, is that the approach followed by many web sites is laborious and time-consuming, such that many users may become disinterested in completing the construction process, or even starting it. Ideally, for instance, a web site may ask the user a large number of questions that the user has to answer in order for the profile to be constructed. Users who become tired of the process may elect to exit it early, such that profiles are never completed for them. This is disadvantageous to the web site operators, because without knowing much about their users, they are not able to customize the content on their sites to be of maximum interest to the users, which may result in reduced visits to the site or purchases on the site.

Another difficulty with existing active profile construction approaches is that they typically do not allow for depth in the questions they query to the user. For example, the user may be asked, among other of a list of long questions, the interests of the user. If the user responds that he or she is interested in cars, for instance, typically these approaches do not follow up as to the types of cars the user is specifically interested. The degree to which web sites can be personalized based on such existing active profile construction approaches is thus limited. For these and other reasons, therefore, there is a need for the present invention.

### SUMMARY OF INVENTION

The invention relates to the incremental construction of active user profiles for subsequent content customization based thereon, interspersed with content display. Content is displayed based at least on an active profile for a user, where the active profile may initially be empty. The content includes an active-profile inquiry area that has one or more questions. The answers to these questions allow for better construction of the active profile for the user. The user may answer the questions in the inquiry area, or may ignore them and select other content to display. In the latter case, new content is shown to the user, with potentially the same questions displayed in the inquiry area. In the former case, the active profile for the user is updated based on the answers, and the existing content is preferably refreshed to reflect the updated active profile. The inquiry area of the refreshed content then displays new questions that the user can answer to further update his or her profile.

The invention provides for advantages over the prior art. Rather than forcing a user to laboriously answer a lengthy series of questions to construct an active profile for him or her, the invention instead poses a limited number of questions in a delimited area of the content that the user is currently browsing, while the user is browsing the content. The user has the option to answer these questions at any time, or can ignore them and continue browsing the content. However, as the user answers the questions, the active profile is immediately updated, and preferably the content is immediately refreshed, to provide immediate feedback to the user in response to the answering of the questions, and thus ideally to act as an incentive for the user to answer more questions. The user is able to build an active profile at his or her own pace, and is never forced by the invention to answer any profile construction-related questions.

The incremental nature of the active profile construction approach of the invention also affords web site operators to ask follow-up questions to construct an active profile for the user that has a greater degree of depth than in the prior art. For example, once the user has indicated his or her interests, follow-up questions may probe further details regarding these interests. If the user indicates he or she is interested in cars, the follow-up questions may, for instance, inquiry whether the user is interested in specific car lines or models, as well as types of cars, such as classic cars, sports cars, and so on.

It is noted that the invention can be referred to as “1-click-me,” in that the user can in certain embodiments of the invention provide information about him or her with a single click of a pointing device. Still other advantages, aspects, and embodiments of the invention will become apparent by reading the detailed description that follows, and by referring to the accompanying drawings.

### BRIEF DESCRIPTION OF DRAWINGS

FIG. 1 is a flowchart of a method showing the client-server interaction according to an embodiment of the invention that results in active profile construction.

FIG. 2 is a flowchart of an example series of question answering and content display that may result from a particular path through the method of FIG. 1.

FIG. 3 is a diagram of an example web page having an active profile-inquiry area, according to an embodiment of the invention.

FIG. 4 is a diagram of a system including clients, a server, and a network in accordance with which embodiments of the invention may be implemented.

FIG. 5 is a diagram of a computerized device that may be used to implement a server according to an embodiment of the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

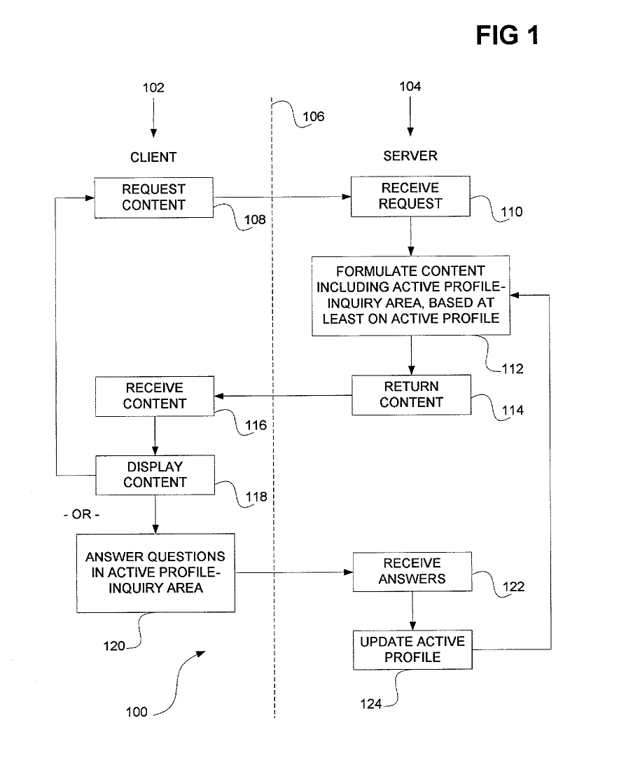

FIG. 1 shows a method 100 according to an embodiment of the invention. Various parts of the method 100 are performed at or by a client, as indicated by the column 102, and at or by a server, as indicated by the column 104, where the columns 102 and 104 are separated by a dotted line 106. First, content is requested at a client (108). For instance, a user may enter in a universal resource locator (URL) of a desired web site in a web-browsing program at the client. The request is transmitted to the server, which receives the request (110). In response, the server formulates the content requested, based at least on an active profile for the user (112). The active profile may be initially empty where the profile has not been previously constructed for the user. The server may further formulate the content based on a passive profile for the user, as has been described in the background section.

For example, there may exist other information about the user, such as the user's history of visiting and browsing through the web site, that can be combined with the active profile of the user in 112 to formulate the content for the user. This information is considered a passive profile, in that the user does not interactively or actively provide the information for inclusion into the profile explicitly for this purpose. The active profile may also combined with other types of active profiles, where the user is asked a series of questions at a given time, as in the prior art.

The content formulated by the server includes an active profile-inquiry area, which is preferably a delimited area within the content in which one or more questions are displayed to the user. Answers to these questions by the user aid the server in constructing an active profile for the user, such that better customized content can be formulated for the user. This content is returned to the client (114), where it is received (116), and displayed to the user (118). At this point, the user can continue browsing without answering the questions posed in the active profile-inquiry area, by, for instance, clicking on a link within the current content that acts as a request for new content. In such instance, parts 108, 110, 112, 114, 116, and 118 of the method 100 are repeated.

Desirably and preferably, however, at some point the user answers the questions in the active-profile inquiry area (120). For example, the questions may ask whether the user is male or female, the income bracket of the user, the area of the country or of the world in which the user resides, and so on. These answers are sent to the server, which receives them (122). In response, the server updates the active profile for the user (124), such that the current content may, but not necessarily, be reformulated based on the newly updated active profile for the user (112). Furthermore, new questions are inserted in the active profile-inquiry area, for the user to next answer if he or she so desires. This updated content is returned to the client (114), where it is received (116) and displayed (118), such that the method 100 repeats as before.

By interspersing a limited number of questions, such as only a single question, within the content, the method 100 achieves an incremental approach to active profile construction that desirably is not burdensome to the user. The user has the choice at any time to ignore the questions, and continue to browse the web site. However, the user also has the choice to answer the questions, which preferably causes the existing content to be updated to reflect the active profile updated with these answers. New questions are then posited to the user, the answers to which further update and refine the user's active profile. Active profile construction thus involves the user at a pace determined by the user, and which should never be laborious for the user.

The term question as used herein is inclusive of any type of prompt to the user to obtain information from him or her for incremental construction of an active profile. For example, all of the following queries to the user are considered questions as that term is used herein: “click on your home state”; “do you want to receive sports information?”; “select the types of information you would like to receive and click submit”; and so on. That is, even though only the second query of these example queries is literally a question, all of the queries are considered questions as this term is used herein. Furthermore, the active profile may be for the user in that it is about an entity related to the user in some way, such as his or her employer or work location. For example, a question in this respect may be “how many employees work at your location?”.

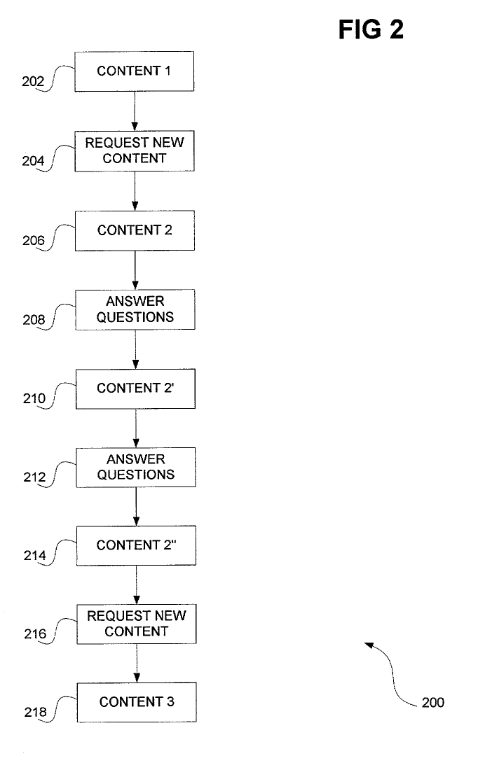

FIG. 2 shows an example path 200 through the method 100 of FIG. 1. First content may be displayed to the user (202), in response to which the user requests new content (204), which is then displayed to the user as second content (206). The user then decides to answer the questions shown within the active profile-inquiry area of this content (208), which causes an updated version of the second content, reflecting the updating of the profile based on these answers, to be displayed (210). The user may decide to answer new questions shown to the user in this updated version of the second content (212), which again causes an even more refined version of the second content to be displayed (214). At this point, the user may decide to instead request new content again (216), which is displayed to the user as third content (218).

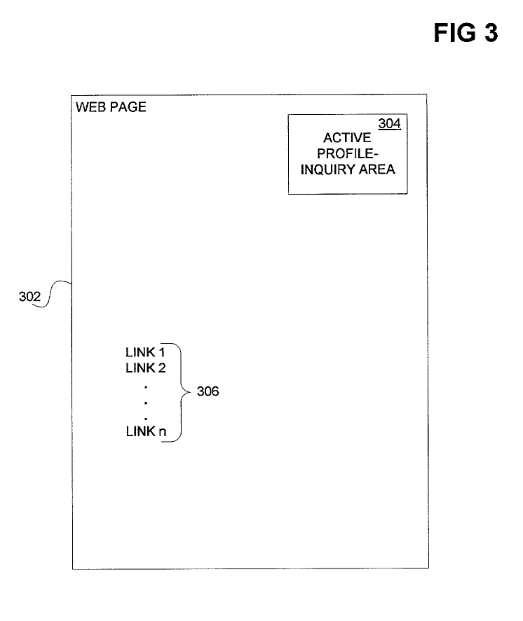

FIG. 3 shows a diagram of an example web page 302 that may act as the content in an embodiment of the invention. Other types of content besides web pages, however, are amenable to the invention. The web page 302 includes an active profile-inquiry area 304 in the upper-right hand corner of the page 302, in which one or more questions are posed to the user for profile-updating purposes. The area 304 being located in the upper-right hand corner of the page 302 is only an example of such area placement, and does not represent a limitation of the invention itself. Where the area 304 includes only one question, preferably only a single action of the user, such as a single click of a pointing device by the user on one or more-answer choices provided in the area 304, is required for the user to answer the question. Furthermore, the web page 302 includes a number of links 306 that the user can select as a way to request new content, where each of the links 306 is to another web page within the web site of which the page 302 is a part.

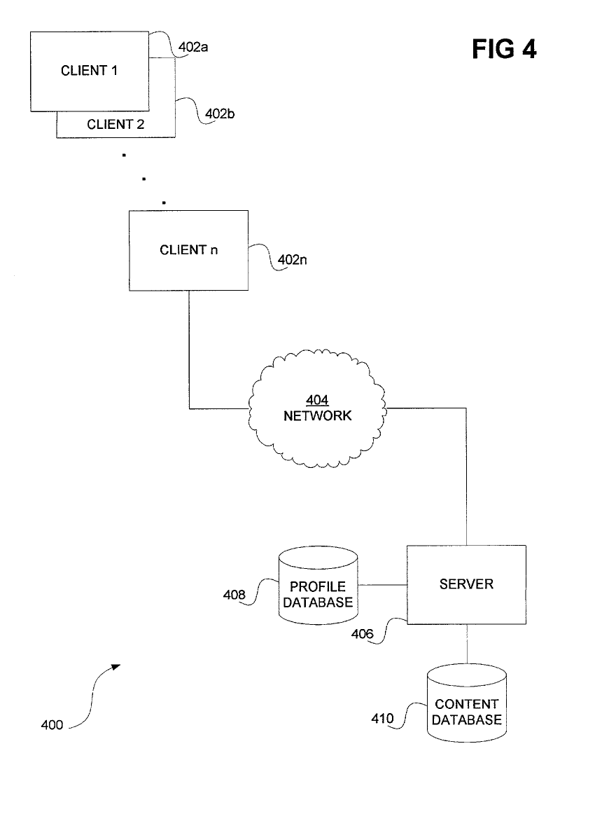

FIG. 4 shows an example system 400 in accordance with which embodiments of the invention may be implemented. The system 400 includes a number of clients 402a, 402b, . . . , 402n, a network 404, and a server 406. Each of the clients 402a, 402b, . . . , 402n may be a computer on which a web browsing program is running. The clients may be any type of computerized device, such as traditional computers, handheld devices like mobile phones, personal digital assistant (PDA) devices, MP3 and other music playing devices, home appliances, in-car computer systems, and other types of computerized devices. The clients are communicatively connected to the network 404. The network 404 may be one or more of an intranet, an extranet, the Internet, a local-area network (LAN), a wide-area network (WAN), a wired network, and a wireless network, as well as other types of networks. The server 406 is also communicatively coupled to the network 404.

The server 406 in the system 400 has access to a profile database 408 and a content database 410. The profile database 408 stores active profiles of the users of the clients 402a, 402b, . . . , 402n. Alternatively, these profiles may be stored on the clients themselves, as cookies or other types of files, or the profiles may be stored in a distributed manner over the clients themselves and the database 408. The content database 410 stores the raw content that is formulated by the server 406 for return to the clients. The server 406 may itself also be a computer.

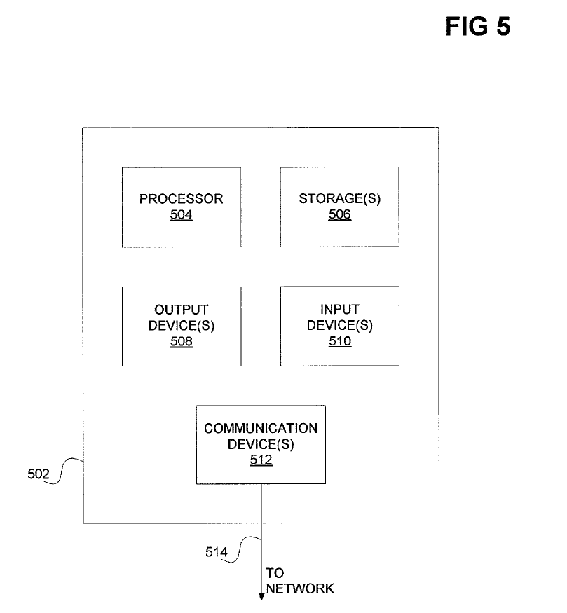

FIG. 5 shows an example of a computerized device 502, that can be used as the server 406 and/or any of the clients 402a, 402b, . . . , 402n of FIG. 4. The device 502 includes a processor 504, storage(s) 506, output device(s) 508, input device(s) 510, and communication device(s) 512. Preferably, the processor 504 executes computer programs that are stored on the storage(s) 506. For example, the computer programs may include a computer program to implement the functionality of the method 100 of FIG. 1 as has been described, in various means of the program.

The storage(s) 506 may include removable storages, such as floppy disk drives and CD-ROM drives, permanent storages, such as hard disk drives, non-volatile memories, and volatile memories. The output device(s) 508 may include displays, printers, speakers, and so on. The input device(s) 510 may include keyboards, pointing devices such as mice, scanners, and so on. The communication device(s) 512 enable the device 502 to communicatively connect with a network, as indicated by the line 514, and may include network adapters, modems and so on.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method comprising:
displaying content based on at least an active profile for a user, the content including an active profile-inquiry area having one or more questions, the answers to which allow for better construction of the active profile for the user;
in response to the user answering the one or more questions within the active profile-inquiry area,
updating the active profile for the user; and,
repeating the method with one or more new questions, and the content being changed to reflect the active profile having been updated.

2. The method of claim 1, further comprising in response to the user requesting other content, displaying the other content based on at least the active profile for the user, the other content including the active profile-inquiry area having the one or more questions.

3. The method of claim 1, wherein displaying the content based on at least the active profile for the user comprises displaying the content based on at least the active profile for the user and a passive profile for the user, the passive profile constructed without direct interaction with and input from the user for this purpose.

4. The method of claim 1, wherein the one or more questions within the active profile-inquiry area consists essentially of a single question.

5. The method of claim 4, wherein the user answering the one or more questions comprises the user answering the single question with a single action.

6. The method of claim 5, wherein the single action comprises a single click of a pointing device by the user.

7. The method of claim 1, wherein the content comprises a web page.

8. A computer-readable medium having instructions stored thereon for execution by a processor to perform a method comprising:
receiving a request for first content over a network from a client of a user;
formulating the first content based on at least an active profile for the user, the first content including an active profile-inquiry area having one or more questions, the answers to which allow for better construction of the active profile for the user;
returning the first content over the network to the client of the user for display to the user by the client;
in response to receiving a request for second content over the network from the client of the user,
formulating the second content based on at least the active profile for the user, the second content including the active profile-inquiry area having the one or more questions, and
returning the second content over the network to the client of the user for display to the user by the client; and,
in response to receiving an answer to each of the one or more questions over the network from the client of the user,
updating the active profile for the user based on the answer to each of the one or more questions,
formulating third content based on at least the active profile for the user, the third content differing from the first content in that the third content reflects the active profile having been updated, the third content including the active profile-inquiry area but having one or more new questions, the answers to which allow for better construction of the active profile for the user, and
returning the third content over the network to the client of the user for display to the user by the client.

9. The medium of claim 8, wherein formulating the first content, the second content, and the third content based on at least the active profile for the user comprises formulating the first content, the second content, and the third content based on at least the active profile for the user and a passive profile for the user, the passive profile constructed without direct interaction with and input from the user for this purpose.

10. The medium of claim 8, wherein the one or more questions within the active profile-inquiry area consists essentially of a single question.

11. The medium of claim 10, wherein receiving the answer to each of the one or more questions comprises receiving the answer to the single question.

12. The medium of claim 8, wherein the first content, the second content, and the third content each comprise a web page.

13. The medium of claim 8, wherein the network comprises one or more of: an intranet, an extranet, the Internet, a local-area network (LAN), a wide-area network (WAN), a wired network, and a wireless network.

14. The medium of claim 8, wherein the medium comprises one or more of: a removable storage, a permanent storage, and a modulated data signal.

15. A server comprising:
a processor;
a storage; and,
a computer program executed by the processor from the storage and comprising:
means for receiving a request for first content over a network from a client of a user;
means for formulating the first content based on at least the active profile for the user, the first content including an active profile-inquiry area having one or more questions, the answers to which allow for better construction of the active profile for the user;
means for returning the first content over the network to the client of the user for display to the user by the client;
means for, in response to receiving an answer to each of the one or more questions over the network from the client of the user,
updating the active profile for the user based on the answer to each of the one or more questions,
formulating second content based on at least the active profile for the user, the second content differing from the first content in that the second content reflects the active profile having been updated, the second content including the active profile-inquiry area but having one or more new questions, the answers to which allow for better construction of the active profile for the user, and
returning the second content over the network to the client of the user for display to the user by the client.

16. The server of claim 15, wherein the computer program further comprises
means for, in response to receiving a request for third content over the network from the client of the user,
formulating the third content based on at least the active profile for the user, the third content including the active profile-inquiry area having the one or more questions, and
returning the third content over the network to the client of the user for display to the user by the client.

17. The server of claim 15, wherein the one or more questions within the active profile-inquiry area consists essentially of a single question.

18. The server of claim 15, wherein the first content and the second content each comprise a web page.

19. The server of claim 15, wherein the network comprises one or more of: an intranet, an extranet, the Internet, a local-area network (LAN), a wide-area network (WAN), a wired network, and a wireless network.

20. The server of claim 15, wherein the storage comprises one or more of: a removable storage, a permanent storage, a volatile memory, and a non-volatile memory.
